(19) United States
(12) Patent Application Publication
(10) Pub. No.: US 2020/0072196 A1
(43) Pub. Date: Mar. 5, 2020

(54) Piston Pump with a High Delivery Rate at a Low Rotational Speed and Use of a Piston Pump in a Wind Turbine

(71) Applicant: KAMAT GmbH & Co. KG, Witten-Annen (DE)

(72) Inventor: Jan G. Sprakel, Witten (DE)

(21) Appl. No.: 16/468,203

(22) PCT Filed: Dec. 12, 2017
(86) PCT No.: PCT/EP2017/082402

§ 371 Date: Jun. 10, 2019

(30) Foreign Application Priority Data
Dec. 12, 2016 (DE) 10 2016 124 048.6

(51) Int. Cl. F03D 9/25; F04B 17/02; F04B 1/20

(52) U.S. Cl. CPC F03D 9/255; F03D 9/30; F04B 1/2092; F04B 17/02

(57) ABSTRACT

Presented is a piston pump comprising: a frame, a control element mounted in a rotatable manner about a central axis with at least one control surface, a plurality of cylinders having pistons displaceable therein, a suction connection for inflow of a fluid into the cylinders, a pressure connection for outflow of the fluid out of the cylinders. The cylinders are connected by lines to the suction and pressure connection. The cylinders, the pistons, and the control element are configured such that the position of the pistons in the cylinders can change by movement of the control element. The cylinders and the pistons are mounted so that they do not rotate completely about the central axis when the control element rotates. So that the piston pump can be operated with low maintenance, it is proposed that the cylinders or the pistons are connected respectively to a rotatably mounted roller.

The invention relates to a piston pump, in particular an axial piston pump or a radial piston pump with a high delivery rate at a low rotational speed, comprising the following: a frame, a control element, which is mounted in a rotatable manner about a central axis and has at least one control surface, a plurality of cylinders, each having pistons displaceable therein, a suction connection for inflow of a fluid into the cylinders of the piston pump, a pressure connection for outflow of the fluid out of the cylinders of the piston pump, the cylinders being connected by lines to the suction connection and to the pressure connection, the cylinders, the pistons, and the control element being designed and arranged such that the position of the pistons in the cylinders can be changed by movement of the control element, and the cylinders and the pistons being mounted in such a way that the cylinders and the pistons do not rotate completely about the central axis when the control element rotates.

The invention furthermore relates to the use of a piston pump in a wind turbine.

Axial piston pumps are—like all pumps—devices for converting mechanical energy into hydraulic energy. Axial piston pumps are piston pumps in which the axes of the cylinders and/or pistons extend parallel to the drive axis of the pump, and therefore “axially”. Typical designs of axial piston pumps are oblique axis pumps and swashplate pumps.

Axial piston pumps are distinguished by high delivery pressures and have—in contrast to radial piston pumps—a small diameter; therefore, although axial piston pumps are rather long in the axial direction, they are constructed very compactly in the radial direction.

Radial piston pumps, on the other hand, are piston pumps in which the axes of the cylinders and/or pistons extend radially with respect to the drive axis of the pump. Although radial piston pumps have a larger diameter, they are constructed very compactly in the axial direction.

In order to achieve a pressure profile which is as uniform as possible and to achieve high delivery rates, axial piston pumps have a plurality of cylinders and pistons, which are distributed in the circumferential direction around a drive axis. The number of cylinders and pistons may be increased further by providing a plurality of groups or rows of cylinders and pistons. In this way, the cylinders and pistons may be arranged so that respectively two cylinders and/or pistons move counter to one another and are mirror-invertedly always in the same position (as in the case of a piston engine in “boxer engine” design). Such double-row axial piston pumps are known, for example, from WO 2004/055369 A1 and WO 2007/054319 A1.

In the double-row axial piston pumps known from WO 2004/055369 A1 and from WO 2007/054319 A1, the driveshaft is connected to two rows of pistons arranged axially (i.e. parallel to the driveshaft), so that rotation of the driveshaft causes rotation of the pistons. Since the pistons are guided displaceably in cylinders, rotation of the pistons about the drive axis leads to rotation of the cylinders about the drive axis. In order to achieve a variation of the cylinder volume during the rotation of the drive axis, the cylinders are arranged not entirely axially, but obliquely. This is achieved by the cylinders sliding on a swashplate which is inclined.

One advantage of these axial piston pumps is that, because of the double-row construction, a large number of pistons and cylinders can be moved with one driveshaft. A disadvantage, however, is the oblique position of the cylinders, which has the effect that the shape of the pistons needs to be elaborately configured and furthermore makes the sealing between the pistons and the cylinders more difficult. Another disadvantage resides in the relative movement between the cylinders and the swashplate, which increases wear and makes the sealing of the contact surface more difficult. Furthermore, configuration of the inlets and outlets in the case of rotating cylinders is complicated and, for example, has to be carried out using annular grooves. These disadvantage are particularly undesirable when high pressures with a low maintenance outlay are required, for example in the case of installation sites which are difficult to access, such as wind turbines.

Multi-row piston pumps are also known in the case of radial piston pumps, for example from WO 2012/073280 A1. In the solution described therein, a plurality of rows of pistons and cylinders are arranged successively in the axial direction. In the solution described therein, the cylinders have rigid cylindrical bodies on the ends protruding from the cylinders, these bodies being intended to slide on a multi-piece and wave-shaped cam ring and being intended to push the pistons into the cylinders. Because of the high sliding friction between the cam ring and the cylindrical bodies, contact between the cam ring and the cylindrical bodies can take place only with an oil-filled space, which makes the construction and the sealing of the entire device very complicated. Furthermore, the oil increases the rotational resistance, which reduces the efficiency of the device. Oil is therefore used as a working fluid and as a lubricant, which in the event of leaks is ecologically problematic (for example in the case of use in the offshore sector).

Against this background, the object of the invention is to configure and refine a piston pump according to the preamble of claim 1, in such a way that, while avoiding the disadvantages mentioned above, the piston pump can achieve a high delivery rate at low rotational speeds.

In the case of a piston pump according to the preamble of claim 1, this object is achieved in that the cylinders or the pistons are connected respectively to a rotatably mounted roller.

The invention relates to a piston pump having a high delivery rate at a low rotational speed; in particular, it may be an axial piston pump or a radial piston pump. For example, the pump may have a delivery rate of at least 1000 litres per minute, preferably several thousand litres per minute, and a rotational speed of 20 revolutions per minute or less. The axial piston pump firstly comprises a frame, which may for example have a front wall and a rear wall. The piston pump furthermore comprises a control element, which is mounted rotatably about a central axis and has at least one control surface. The control element with its control surface is used to control the relative movement between the pistons and cylinders. Preferably, the control element is configured to extend all around and, for example, is configured in the shape of a disc or annularly. In the case of an annular configuration, the control element may be connected by spokes to a hub which is pressed onto a driveshaft. The closed configuration in the circumferential direction has the advantage that the control element can be used along its entire circumference in order to control the pistons and can therefore cause a continuous variation of the piston settings. In addition, the piston pump comprises a plurality of cylinders, each having a piston displaceable therein. The cylinders and the pistons may be arranged in a plurality of groups, which may be separated from one another axially or radially. The piston furthermore comprises a suction connection for inflow of a fluid into the cylinders of the piston pump, and a pressure connection for outflow of the fluid out of the cylinders of the piston pump, the cylinders being connected by lines to the suction connection and to the pressure connection. The piston pump is distinguished in that the cylinders, the pistons and the control element are designed and arranged such that the position of the pistons and the cylinders can be modified by movement of the control element. The control element may, in particular, be moved by rotation. The piston pump is additionally distinguished in that the cylinders and the pistons are mounted in such a way that the cylinders and the pistons do not rotate completely about the central axis during rotation of the control element. Preferably, the cylinders and the pistons—in contrast to the control element—do not rotate at all; it is, however, sufficient that the cylinders and pistons are affixed at least at one point (for example by anchoring on the frame) and are otherwise mobile—for example tiltably mounted. The number of “pump elements” (i.e. units consisting of cylinders and pistons) may for example be at least six, at least eight or at least ten, and may for example lie in the range of between six and thirty.

According to the invention, the cylinders or the pistons are connected respectively to a rotatably mounted roller. It is simpler in terms of design, and to this extent preferred, that the pistons be respectively connected to a rotatably mounted roller, while the cylinders do not have rollers. Nevertheless, as an alternative it would conversely also be possible to provide the cylinders instead of the pistons with rotatably mounted rollers. The function of the rollers will be explained by way of example with reference to rollers arranged on the pistons: the rollers are used for the purpose of rolling on the control surfaces of the control element and guiding the pistons in the axial direction, in other words—depending on the profile of the control surface—pushing them into the pistons or releasing them from the pistons. In contrast to components sliding on one another, guiding by rotatably mounted rollers has the advantage of particularly low friction (rolling friction is usually less than sliding friction). This has the significant advantage that lubrication is simplified. For example, each roller may have encapsulated internal lubrication so that oil lubrication of the rest of the piston pump can be fully avoided. In particular, the contact between the rollers and the control element may take place in a lubricant-free space—the rolling may thus take place “dry”. This opens up new fields of use, for example operation with water, in particular saltwater or seawater, instead of the conventional operation with oil.

According to one configuration of the piston pump, the cylinders or the pistons may be arranged statically and/or tiltably relative to the frame. In this configuration, the cylinders or the pistons are intended to be not only fixed in the circumferential direction, or tangential direction, but static overall (i.e. in every direction). Naturally, only either the cylinders or the pistons may be connected statically to the frame, since relative movement between the cylinders and pistons must be possible: therefore, either the cylinders are connected statically to the frame and the pistons are mounted movably in the cylinders, or the pistons are connected statically to the frame and the cylinders are mounted movably around the pistons. A static arrangement has the advantage that connection of the inlet and outlet lines is significantly simplified. A further advantage resides in the improved sealability, which is important particularly in the case of high pressures and/or high delivery rates. In order to achieve a static arrangement, the cylinders or pistons do not need to be fastened rigidly overall. Rather, it is sufficient to fasten the cylinders or the pistons at one point; this, for example, allows tiltable mounting of the cylinders and pistons about the fastening point, or the fastening axis. Preferably, tiltability of up to 50 is ensured.

In other words, the cylinders and the pistons may be mounted substantially immobile in relation to the central axis in the circumferential direction. In other words, the cylinders and the pistons are not intended to rotate about the central axis during rotation of the control element but are intended to be substantially stationary in the circumferential direction—i.e. in the tangential direction. Movement of the cylinders and the pistons in another direction—in particular a relative movement between the cylinders and pistons in the axial direction or a tilting movement—is however possible. This configuration has the advantage that only the control element is rotated (for example with a driveshaft).

The other components, in particular the cylinders and the pistons, are however not rotated but at most slightly tilted. In this way, some of the disadvantages described in the introduction are avoided, for example problems with sealing and increased wear because of a relative movement between the cylinders and swashplate. By the cylinders and the pistons not being rotated with the control element, the connection of inlet and outlet lines to the cylinders is significantly simplified.

Another embodiment of the piston pump is characterised in that the frame has a front wall and a rear wall for mounting of the cylinders. Preferably, the front wall and the rear wall are configured to be planar, arranged parallel to one another and, for example, connected to one another by spacer rods. In this way, a particularly rigid design can be achieved, which allows high delivery pressures. By a double-walled design, the frame is particularly rigid and—in comparison with a solid design—nevertheless lightweight. The space between the front wall and the rear wall may be used for the arrangement of certain components—for example the pistons and the cylinders—which allows a compact design.

In a further embodiment of the piston pump, the cylinder axes and the piston axes extend coaxially. By a coaxial arrangement of cylinders and pistons, sealing is made easier. Furthermore, in contrast to an angled arrangement, in a coaxial arrangement transverse forces are avoided. A further advantage is that the piston may be shaped cylindrically and therefore simple to produce.

In respect of the control surface, in a further configuration of the piston pump, the control surface of the control element is configured in such a way that a plurality of strokes is executed per revolution. By providing a plurality of strokes per revolution, a high delivery power can be achieved even at low rotational speeds. In this way, gearing can often be avoided. In design terms, this may for example be achieved in that the control surface has a plurality of projections (“ridges”) or recesses (“valleys”) along its circumference or is configured overall with a wave-shape. A wave valley (=small axial extent of the control element) has the effect that the piston can be pushed further out of the cylinder, and a wave ridge (=large axial extent of the control element) has the effect that the piston can be pushed further into the cylinder. Preferably, the control surface of the control element is configured in such a way that at least four, in particular at least six, in particular at least eight or even at least ten strokes are executed per revolution, i.e. per 360° movement of the control element. Particularly good results are achieved with control elements whose control surface is configured in such a way that between 10 and 30 strokes, in particular at least 15 and 25 strokes, for example 18, 20 or 22 strokes per revolution are executed. Preferably, the number of cycles of a control surface in the circumferential direction is not equal to the number of pistons driven by this control surface. This has the effect that the pistons are pushed into the cylinders not simultaneously but successively, which leads to a more uniform pressure profile. The control surfaces may, for example, be configured with a wave-shape.

According to a further configuration of the piston pump, the pistons have a spring for retraction of the pistons from the cylinders. The springs are used to generate restoring forces when the pistons are pushed into the cylinders. This has the advantage that the pistons do not need to be withdrawn actively from the cylinder but are automatically pushed out of the cylinder again as soon the control element frees the space required for this. The use of springs furthermore has the advantage that the pistons can be driven by components which can transmit only pressure forces but not tensile forces, for example rollers which roll on the control surfaces of the control element. The springs may, for example, be helical springs which enclose the pistons or piston rods.

In another embodiment of the piston pump, the contact region between the rollers and the control surface of the control element may be lubricant-free. Since the rollers can roll on the control surface, in contrast to sliding solutions it is possible to avoid the use of lubricant in the contact region. The rolling of the rollers on the control surface is thus intended to take place “dry”. This simplifies the construction of the piston pump significantly, since it is not necessary to form an (oil) space which is to be sealed around the contact region. Nevertheless, the rotatability of the rollers themselves may be ensured or improved by the use of lubricant, for example by lubricated rolling bearings. Preferably a linear contact is formed between the rollers and the control surface of the control element, for example by using cylindrical rollers.

According to a further configuration of the piston pump, the cylinder axes and the piston axes extend parallel to the central axis. Such a construction is also referred to as an “axial piston pump”. By the parallel arrangement, it is possible to achieve the effect that the extent of the piston pump in the radial direction is particularly compact, since the cylinders and the pistons extend only in the axial direction. A further advantage of axial orientation is that the pistons—unlike in the case of an oblique arrangement—have the same radial distance from the central axis in every piston setting and can therefore be driven particularly well by the control element.

Another embodiment of the piston pump is distinguished by a first group of at least one, preferably of at least two cylinders, each having a piston movable therein, and a second group of at least one, preferably of at least two cylinders, each having a piston movable therein. By a plurality of groups of cylinders and pistons, the delivery power can be increased. Furthermore, pressure variations can be reduced. Preferably, all the cylinders of a group are arranged on the same side of the control element.

For this embodiment, it is furthermore proposed that the first group of cylinders with their pistons and the second group of cylinders with their pistons be arranged on different sides of the control element in the axial direction. The control element is thus intended to be arranged between the two groups of cylinders and pistons, and to control both groups. This arrangement has several advantages: first, a particularly compact design is achieved since one control element can be used for controlling both groups of cylinders and pistons. Secondly, with corresponding arrangement and driving of the cylinders and pistons, as a main advantage, axial force balancing can be achieved by opposing forces compensating for one another, which leads to smoother running with less vibrations (corresponding to the principle of a boxer engine in vehicle construction).

According to another configuration of the piston pump, the control surfaces of the control element are directed in the axial direction, and their axial distance from the cylinders can be modified by rotation of the driveshaft. This orientation of the control surfaces has the advantage that axially oriented pistons can be driven particularly well, for example by rollers mounted on the pistons rolling on the control surfaces, or other suitable components sliding on the control surfaces. The effect of a variation of the axial distance is that the component—for example the piston—driven by the control element changes its axial position. This leads to a variation of the cylinder volume and therefore to a pump effect. Preferably, the variation of the axial distance takes place cyclically, i.e. repeatedly. Preferably, the cycle is repeated in the circumferential direction several times per revolution. A plurality of strokes per revolution are thus executed.

According to a further configuration of the piston pump, the cylinder axes and the piston axes extend radially with respect to the central axis. Such a construction is often referred to as a “radial piston pump”. By the radial—in other words, directed outward from the central axis—arrangement, it is possible to achieve the effect that the extent of the piston pump in the axial direction is particularly compact since the cylinders and the pistons extend only in the radial direction. A further advantage of radial orientation is that the plurality of rows of radially arranged cylinders and pistons may be sequenced in the axial direction (modular design).

In another embodiment of the piston pump, the control element is arranged outside the cylinders and the pistons in the radial direction and annularly encloses them. The control element is thus intended to be configured as a large ring, in the middle of which the pistons and cylinders are arranged. This has the advantage of a particularly compact design in the axial direction. Furthermore, the annular configuration of the control element in the case of an inwardly directed control surface allows a radial force balancing when two opposing pistons are simultaneously pushed inwards—i.e. in the direction of the central axis—by the control element. Arrangement of the cylinders and pistons inside the control element furthermore has the advantage that the control element is easily accessible from the outside. This allows introduction of the drive power into the control element from the outside—for example by the rotor of a wind turbine.

According to another configuration of the piston pump, the control surface of the control element is directed in the radial direction with respect to the central axis, and its radial distance from the cylinders can be modified by rotation of the control element about the central axis. An inwardly directed control surface allows a radial force balancing when two opposing pistons are simultaneously pushed inwards—i.e. in the direction of the central axis—by the control element. Furthermore, such a control surface makes it possible to arrange the cylinders and the pistons inside the control element, which leads to a very compact design in the radial direction.

A further configuration of the piston pump is distinguished by trailing arms for guiding the rollers, each roller preferably being assigned a trailing arm. During the rolling of the rollers on the control surface of the control element, introduction of transverse forces into the “pump element” (unit consisting of pistons and cylinders) may take place. This is because the control surface also introduces forces extending obliquely with respect to the piston axis into the pistons—for example when the roller rolls “uphill”. These transverse forces are intended to be absorbed and supported by the trailing arms. To this end, the trailing arms are preferably connected at one end (rotatably) to the rollers and at the other end statically affixed (likewise rotatably) on the piston pump (for example on the frame of the piston pump). With a constant length of the trailing arm, this type of mounting leads to a slight tilting movement of the “pump element”, which is readily possible because of the corresponding tiltable mounting of the cylinder.

For this embodiment, it is furthermore proposed that the trailing arms be mounted rotatably on a static support ring. The support ring may, for example, be fastened on the frame of the piston pump. It may be configured in the shape of a ring and arranged next to the control element in the axial direction. In this way, there is a particularly short distance between the support ring and the control element, so that the trailing arms can be made very short and therefore lightweight.

In all configurations presented, the piston pump described above is particularly highly suitable to be used in a wind turbine. The piston pump may be used both in a wind turbine with a horizontal rotation axis and in a wind turbine with a vertical rotation axis. Preferably, the wind turbine has a rotor and a turbine, the rotor being mechanically connected to the piston pump, and the piston pump and the turbine being connected to one another by fluid lines. Wind turbines having a horizontal rotation axis often additionally have a tower with a gondola for mounting the rotor, a sufficient distance of the rotor blades from the ground being ensured. In the case of wind turbines having a vertical rotation axis, on the other hand, a tower and a gondola may be omitted since the rotation in this case takes place in a plane lying parallel to the ground.

According to one configuration of the use, the wind turbine has a tower with a gondola and a rotor, a piston pump and a turbine, the rotor being mechanically connected to the piston pump, and the piston pump and the turbine being connected to one another by fluid lines. This is a particularly widespread form of installation. Instead of a turbine, it is also—more generally—possible to use a hydraulic load. Preferably, the rotor is connected to the piston pump without intermediate gearing—i.e. without transformation—so that the rotational speed of the rotor always corresponds to the rotational speed of the pump.

In conventional wind turbines, the rotor is connected via gearing to an electrical generator so that the conversion of mechanical energy into electrical energy takes place inside the “gondola” and therefore in great spatial proximity to the rotor. This procedure has several disadvantages. One disadvantage is that variations in the wind strength (for example gusts of wind) lead to variations in the torque, which may cause damage to the gearing. A further disadvantage is that, particularly in offshore installations, the gearing is exposed to increased corrosion because of salty air. Arranging the electrical generator and the required power electronics in the gondola may also prove to be problematic since, above all in offshore installations, more difficult accessibility leads to very high maintenance costs.

In order to avoid these disadvantages, individual approaches are known which provide the use of fluid-technology machines (in particular pumps and turbines). One such solution is known, for example, from WO 2012/073280 A1. According to this solution, the rotor is connected to a hydraulic radial piston pump, which is connected to a hydraulic motor. The hydraulic motor is in turn connected to an electrical generator. The idea is thus to replace mechanical gearing with hydraulic gearing (consisting of the hydraulic radial piston pump and the hydraulic motor). Although this solution removes the disadvantages associated with mechanical gearing, as before it provides arrangement of the electrical generator in the gondola, which has the disadvantages described above. A further disadvantage is, as already described in the introduction, that it involves a fluid-lubricated pump, which makes the construction and sealing very complicated. In addition, the oil increases the rotational resistance, which reduces the efficiency. Lastly, when used in a wind turbine, oil escaping would cause serious environmental damage. To date, the solution described in WO 2012/073280 A1 has not become established because of the disadvantages described.

In order to avoid these disadvantages, according to the invention it is proposed to use a piston pump according to one of claims 1 to 16. The use of an axial piston pump has the advantage that the installation space of the gondola of the wind turbine can be utilised particularly well. For reasons of flow technology, in particular the height and the width of the gondola are limited. This requirement can be satisfied by an axial piston pump, since axial piston pumps are distinguished by a particularly compact design in the radial direction. The use of a radial piston pump, on the other hand, has the advantage of a design which is particularly narrow in the axial direction. This has the advantage that a radial piston pump may be fastened on the rotor and may be mounted together with the rotor on the gondola of a wind turbine. In addition, a plurality of radial piston pumps may be sequenced in the axial direction in order to increase the delivery power.

Utilisation of the installation space of the gondola is also important since the rotors of wind turbines are usually operated only at a very low rotational speed (for example from 10 rpm to 30 rpm) and as far as possible no mechanical gearing for transformation is intended to be used. The pump must therefore be capable of generating a high delivery rate from low rotational speeds. The design measures needed for this require a large spatial extent of the pump.

According to one configuration of the use, the piston pump is arranged in the gondola and the turbine is arranged outside the gondola and outside the tower. This configuration has the aim of relocating the energy conversion taking place in the turbine to outside the gondola. This has the consequence that the electrical generator driven by the turbine may also advantageously be arranged outside the gondola. To this end, the fluid lines need to be fed out from the gondola and from the tower in order to connect the axial piston pump to the turbine. Arranging the turbine and the generator outside the gondola has, for example, the advantage that there are scarcely any restrictions in terms of installation space. It is therefore possible to use larger turbines and generators, to which a plurality of pumps from different gondolas may be connected. Another advantage is that maintenance-intensive parts may either be fully avoided (mechanical gearing) or relocated from the gondola to more easily accessible places (turbine).

According to a further embodiment of the use, the wind turbine has an electrical generator and an electrical transformer, which are arranged outside the gondola and outside the tower. This design has the aim of relocating the conversion of mechanical energy into electrical energy to outside the gondola. This also has the advantages already described, in particular no installation space restrictions and better accessibility for maintenance purposes.

In another configuration of the use, water, in particular seawater, is used as the pump medium. The use of water as a pump medium has, in particular, ecological advantages since water as a pump medium can be simply replenished or discharged into the environment. This represents a major difference from oil as the pump medium, which may cause great environmental damage even with small amounts of leakage. Particularly in offshore wind turbines, the use of water as a pump medium has great advantages since this medium is present on site in a virtually unlimited supply and therefore—for example in the event of maintenance work—and easily be discharged and subsequently replenished. The axial piston pump described above is particularly highly suitable for the use of water as a pump medium, since this pump does not need to be lubricated by the delivery medium.

According to a further embodiment of the use, lastly, the wind turbine has a supply pump. In particular, the supply pump may be arranged outside the gondola and outside the tower and integrated into the fluid circuit of the piston pump and the turbine. The additional supply pump is used for the purpose of delivering the pump medium—for example water—to the piston pump. Because of the large height difference, an additional supply pump may be useful since the piston pump can draw in the pump medium only up to a limited height.

In this case as well, the piston pump may for example be an axial piston pump or a radial piston pump.

The invention will be explained in more detail below with the aid of a drawing which merely represents a preferred exemplary embodiment. In the drawing:

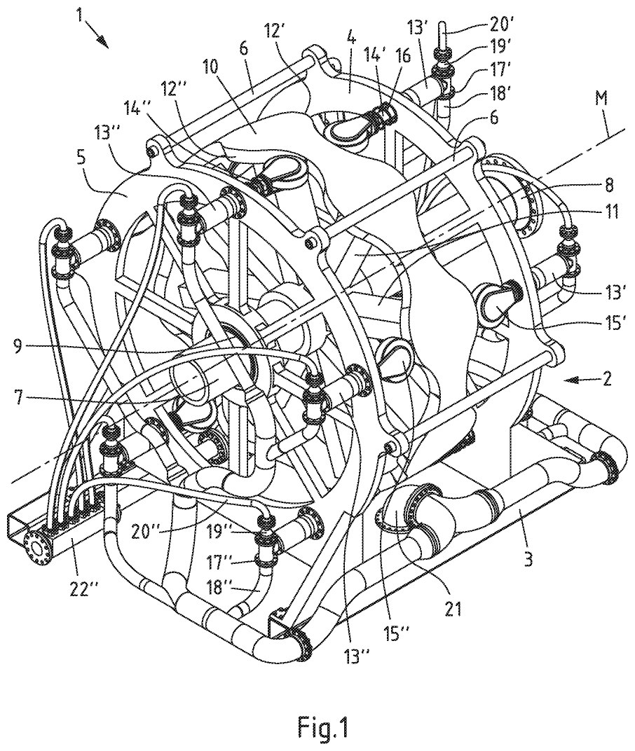

FIG. 1 shows an axial piston pump according to the invention in perspective view,

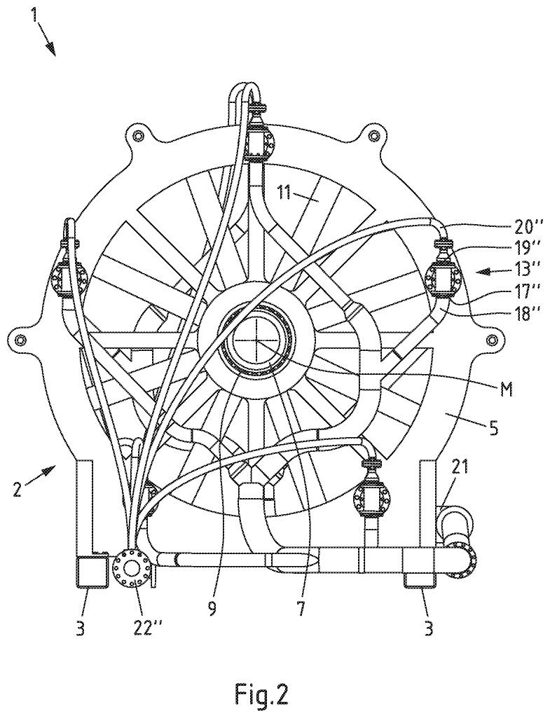

FIG. 2 shows the axial piston pump of FIG. 1 in a rear view,

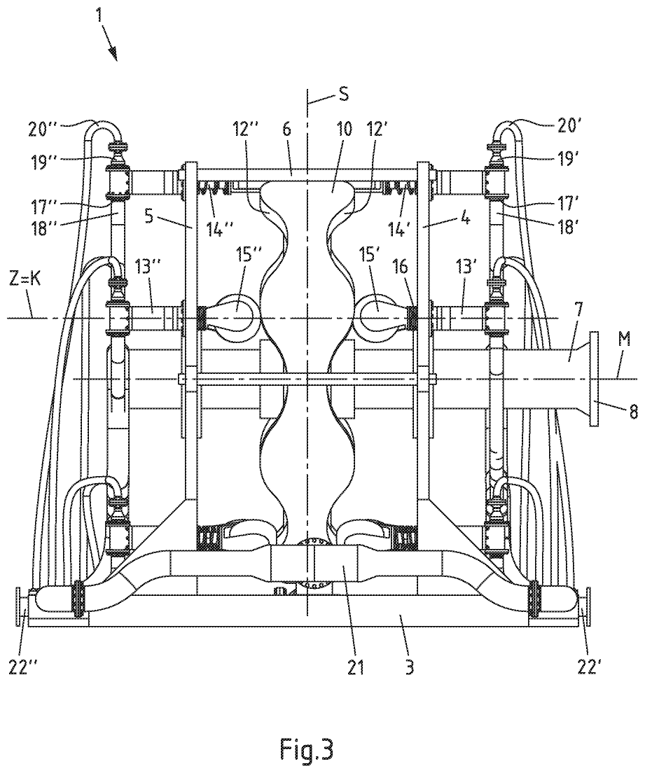

FIG. 3 shows the axial piston pump of FIG. 1 in a side view,

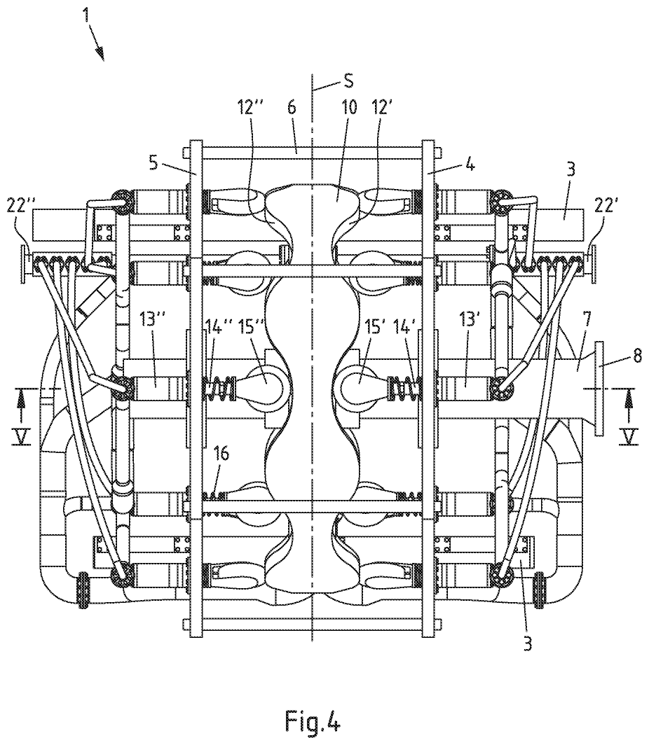

FIG. 4 shows the axial piston pump of FIG. 1 in a plan view,

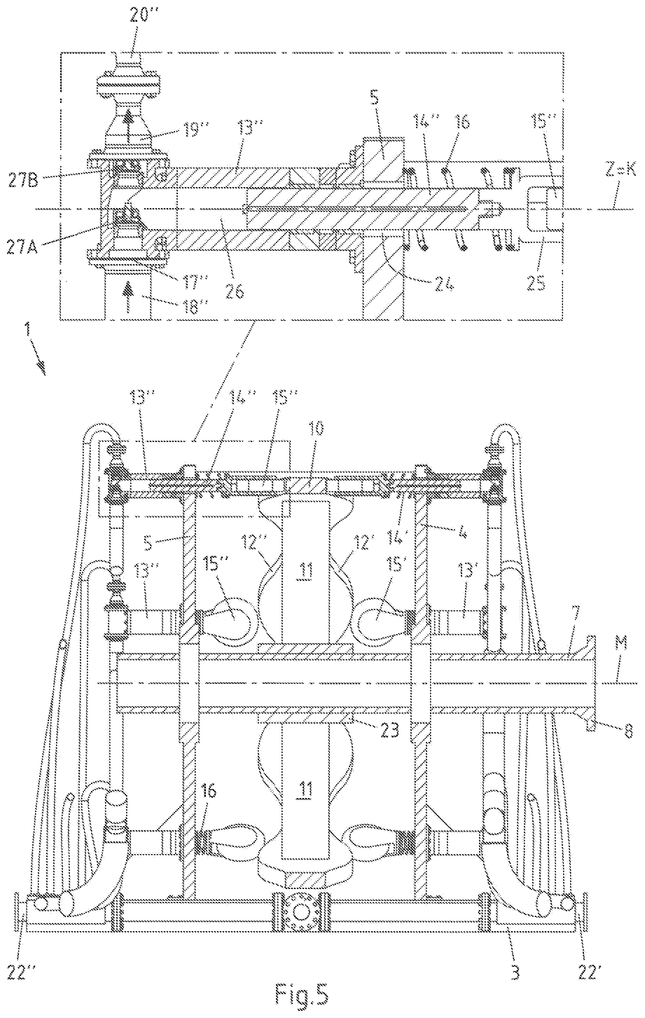

FIG. 5 shows the axial piston pump of FIG. 1 in a sectional view along the section plane V-V indicated in FIG. 4,

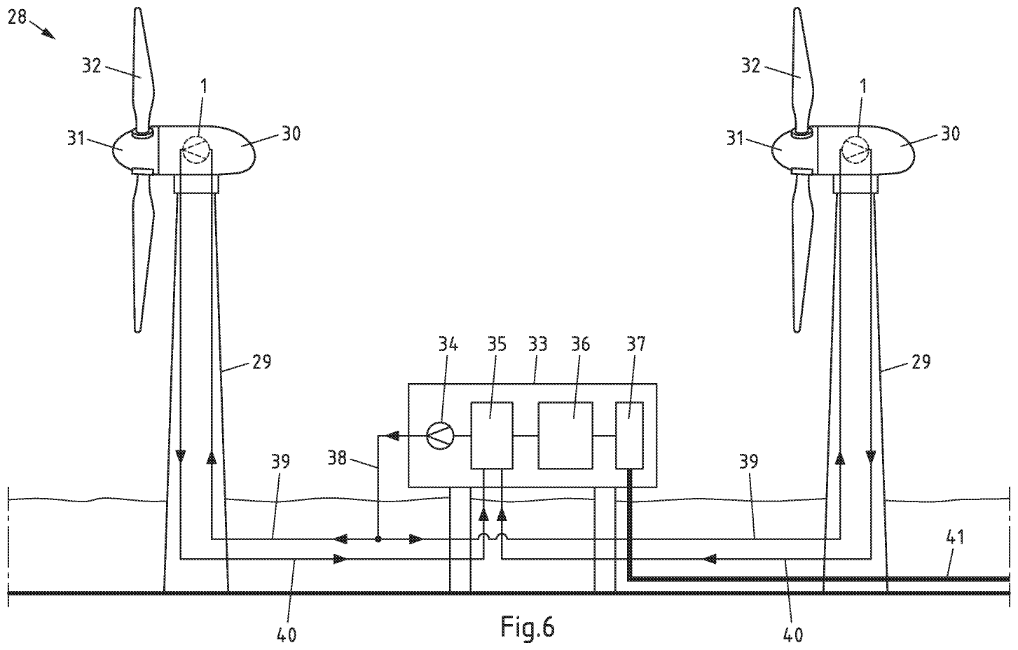

FIG. 6 shows the use of the axial piston pump of FIG. 1 in an offshore wind turbine in a schematic representation,

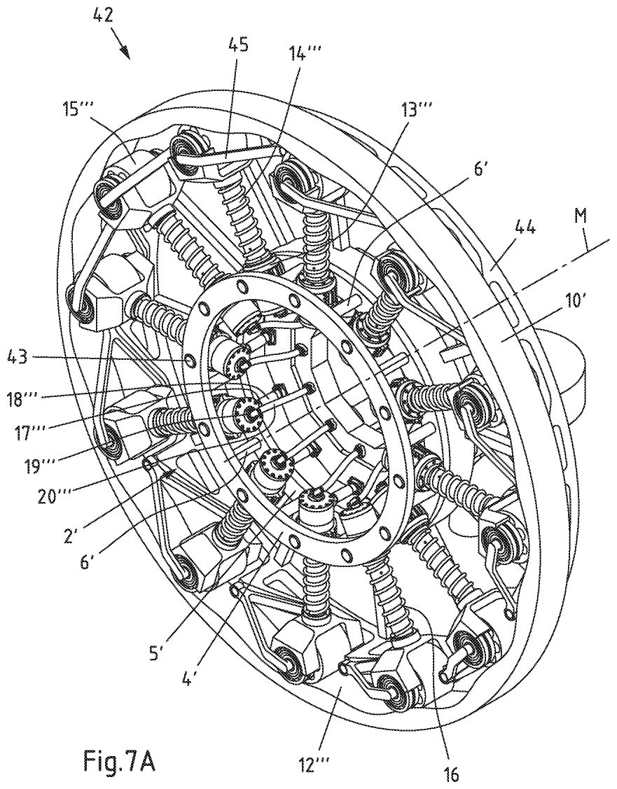

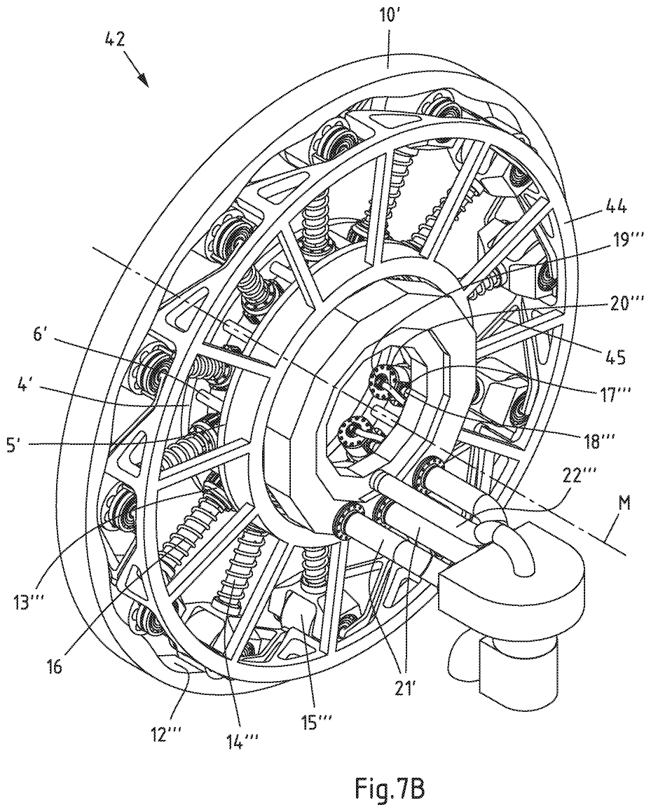

FIG. 7A shows a radial piston pump according to the invention in perspective view from the front side,

FIG. 7B shows the radial piston pump of FIG. 7A in perspective view from the rear side,

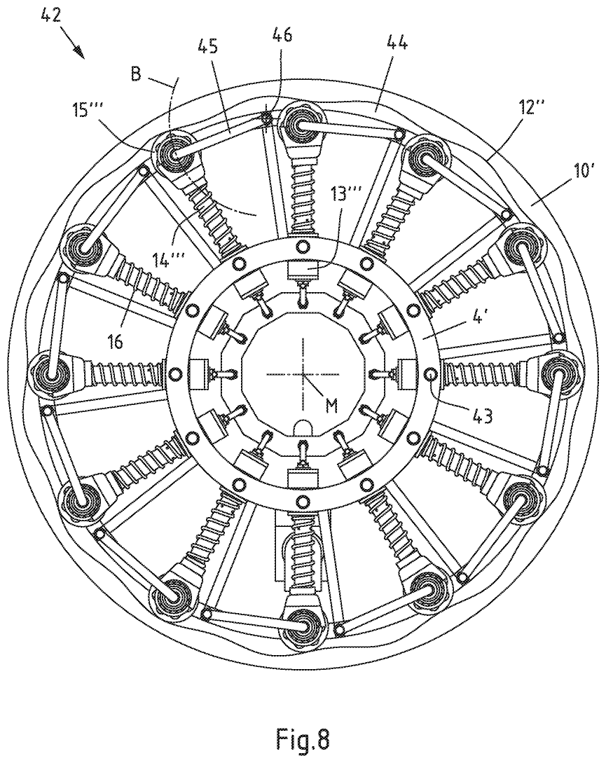

FIG. 8 shows the radial piston pump of FIG. 7A in a front view,

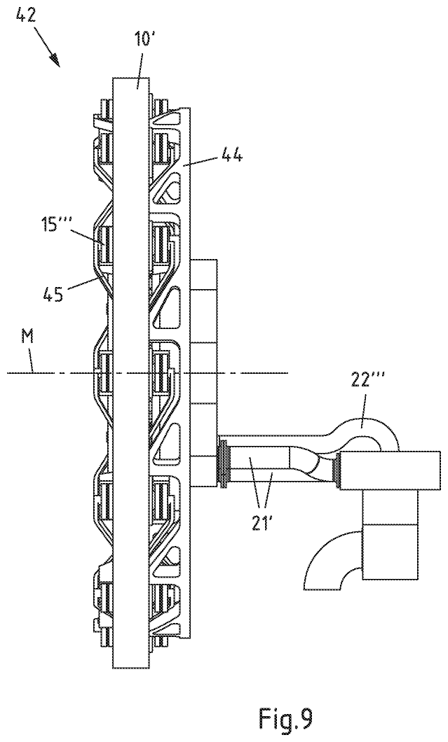

FIG. 9 shows the radial piston pump of FIG. 7A in a side view,

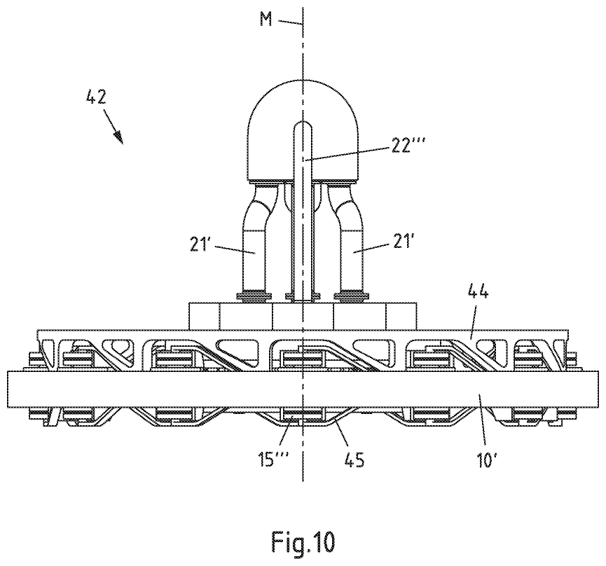

FIG. 10 shows the radial piston pump of FIG. 7A in a plan view, and

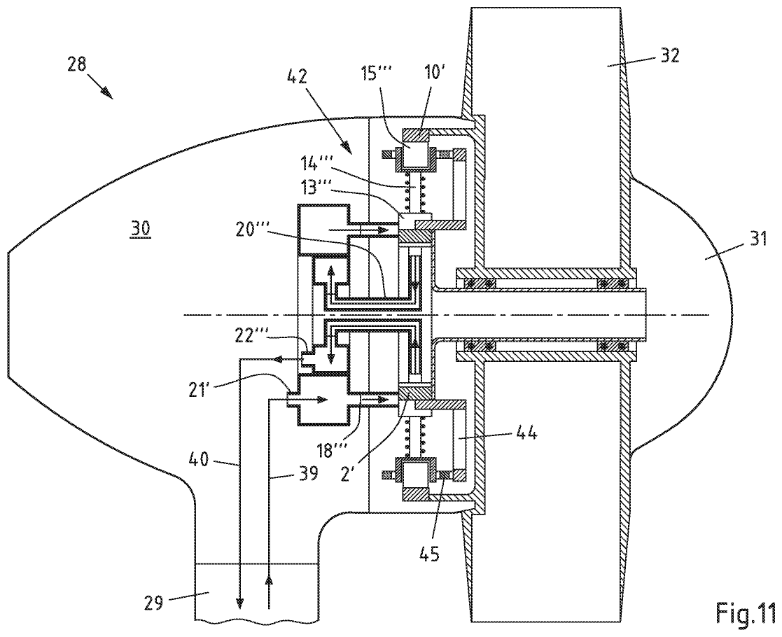

FIG. 11 shows the use of the radial piston pump of FIG. 7A in an offshore wind turbine in a schematic representation.

FIG. 1 shows an axial piston pump 1 according to the invention in a perspective view. The axial piston pump 1 has a frame 2, which comprises two base stands 3, a front wall 4 and a rear wall 5. The front wall 4 and the rear wall 5 are approximately round and are separated from one another by a plurality of spacer rods 6 distributed over the circumference, in such a way that the front wall 4 and the rear wall 5 are arranged in parallel planes. Rotatably mounted in the frame 2 there is a driveshaft 7, at the end of which a flange 8 is provided. A rotor shaft (not shown in FIG. 1) of a wind turbine may for example be connected to the flange 8. The driveshaft 7 is arranged on a central axis M extending centrally through the axial piston pump 1. The driveshaft 7 is mounted rotatably in the housing 2 by two bearings 9, one bearing 9 being arranged in the front wall 4 and the other bearing 9 being arranged in the rear wall 5.

The axial piston pump 1 shown in FIG. 1 furthermore has an annular control element 10, which is connected, while being fixed non-rotatably, by a plurality of spokes 11 to the driveshaft 7. A rotational movement of the driveshaft 7 therefore leads to a rotational movement of the control element 10. The control element 10 has two opposing control surfaces 12, 12′, each of which is directed in the axial direction and is configured with a wave-shape. Furthermore, the axial piston pump 1 shown in FIG. 1 has ten cylinders 13′, 13′ and ten pistons 14′, 14′ assigned to these ten cylinders.

The cylinders 13 and the pistons 14 of the axial piston pump 1 shown in FIG. 1 may be divided into two groups: the five front cylinders 13′ are affixed on the front wall 4, the five front cylinders 13′ being arranged circularly around the central axis M and oriented in the axial direction—i.e. coaxially with the central axis M. The five front pistons 14′ are mounted movably in the axial direction in the five front cylinders 13′, and therefore likewise arranged circularly around the central axis M and oriented in the axial direction—i.e. coaxially with this central axis M. The five rear cylinders 13″, on the other hand are affixed on the rear wall 5, the five rear cylinders 13″ being arranged circularly around the central axis M and oriented in the axial direction—i.e. coaxially with the central axis M. The five rear pistons 14″ are mounted movably in the axial direction in the five rear cylinders 13″, and are therefore likewise arranged circularly around the central axis M and oriented in the axial direction—i.e. coaxially with this central axis M.

In the axial piston pump shown in FIG. 1, the pistons 14′, 14″ are connected—for example by means of piston rods—to rotatably mounted rollers 15. The rollers 15 may also be divided into two groups: front rollers 15′ are mounted rotatably on the front pistons 14′, and rear rollers 15″ are mounted rotatably on the rear pistons 14″. The rollers 15 are arranged in such a way that they roll on the control surfaces 12 of the control element 10, the front rollers 15′ rolling on the front control surface 12′ and the rear rollers 15″ rolling on the rear control surface 12″. Because of the wave-shaped configuration of the control surfaces 12, the position of the control surfaces 12 in the axial direction varies during rotation of the control element 10. The effect of this is that, when there is an increased axial width of the control element 10 (greater axial distance between the two control surfaces 12′, 12″) the two rollers 15′, 15″ are pushed in the axial direction outwards (i.e. in the direction of the front wall 4 and the rear wall 5). The result of this is that the pistons 14′, 14″ connected to the rollers 15′, 15″ are pushed into the cylinders 13′, 13″ assigned to them, and in doing so displace the fluid located in the cylinders 13′, 13″. On the other hand, a reduced axial width of the control element 10 (smaller axial distance between the two control surfaces 12′, 12″) has the effect that the rollers 15′, 15″ are moved inwards in the axial direction (i.e. in the direction of the control element 10). To this end, the axial piston pump 1 has ten springs 16, which are arranged in such a way that they push the pistons 14′, 14″ out of the cylinders 13′, 13″. For example, a helical spring 16 is wound around each piston 14′, 14″. The effect of the spring forces is that the rollers 15′, 15″ always follow the contour of the control surfaces 12′, 12″, and the pistons 14′, 14″ connected to the rollers 15′, 15″ are withdrawn again from the cylinders 13′, 13″ assigned to them; the cylinder volume increasing again. The rollers 15′, 15″ are thus mounted in such a way that they roll on the control surfaces 12′, 12″ of the control element 10.

In the axial piston pump 1 shown in FIG. 1, the volume in the cylinders 13′, 13″ can thus be cyclically varied by rotation of the driveshaft 7. In order to be able to use the cyclic variation of the cylinder volumes for the delivery of a fluid, each cylinder 13′, 13″ has an inlet 17′, 17″ with an inlet line 18′, 18″ and an outlet 19′, 19″ with an outlet line 20, 20″. In addition, each cylinder 13 has two non-return valves (not shown in FIG. 1). The inlet lines 18′, 18″ of all the cylinders 13′, 13″ are brought together at a common suction connection 21. In a similar way, the outlet lines 20′ of the front cylinders 13′ are brought together at a common front pressure connection 22′ and the outlet lines 20″ of the rear cylinders 13″ are brought together at a common rear pressure connection 22″. The two pressure connections 22′, 22″ may be brought together at a common pressure connection (not shown in FIG. 1).

In FIG. 2, the axial piston pump 1 of FIG. 1 is represented in a rear view. Those regions of the axial piston pump 1 which have already been described in connection with FIG. 1 are provided in FIG. 2—and in all further figures—with corresponding references. The rear view makes it possible to look at the rear wall 5 of the axial piston pump 1 and at the inlet lines 18″ and the outlet lines 20″ of the rear cylinders 13″ affixed on the rear wall 5. The central axis M and the driveshaft 7 extending along this central axis M can also be seen clearly. In addition, the suction connection 21 and the rear pressure connection 22″ can also be seen in the lower region.

FIG. 3 shows the axial piston pump of FIG. 1 in a side view. In FIG. 3 those regions of the axial piston pump 1 which have already been described in connection with FIG. 1 or FIG. 2 are provided with corresponding references. In the side view, the arrangement of the cylinders 13 and of the pistons 14, which is symmetrical in relation to a symmetry plane S, can be seen particularly well: in each case, a front cylinder 13′ (with a front piston 14′) and a rear cylinder 13″ (with a rear piston 14″) lie on a cylinder axis Z which is arranged parallel to the central axis M—and therefore likewise axially. The cylinder axis Z coincides with a piston axis K, the two axes Z, K thus being colinear. It is therefore an axial piston pump 1 in which the front pistons 14′ and the rear pistons 14″ move counter to one another and are mirror-invertedly always in the same position (as in the case of a piston engine in “boxer engine” design).

In FIG. 4, the axial piston pump 1 of FIG. 1 is represented in a plan view. In FIG. 4 as well, those regions of the axial piston pump 1 which have already been described in connection with FIG. 1 to FIG. 3 are provided with corresponding references. The symmetrical arrangement of many components in relation to the symmetry plane S can also be seen well in the plan view: besides the cylinders 13 and the pistons 14, the front wall 4 and the rear wall 5 are also arranged symmetrically in relation to the symmetry plane S. The internal construction of the axial piston pump 1 will be explained in more detail below in connection with FIG. 5 with the aid of the section plane V-V indicated in FIG. 4.

FIG. 5 shows the axial piston pump 1 of FIG. 4 in a sectional view along the section plane V-V indicated in FIG. 4. In FIG. 5 as well, those regions of the axial piston pump 1 which have already been described in connection with FIG. 1 to FIG. 4 are provided with corresponding references. In the sectional view, it can be seen clearly that the driveshaft 7 is configured as a hollow shaft. Furthermore, the configuration of the non-rotatable connection between the control element 10, its spokes 11 and the driveshaft 7 can be seen: the spokes 11 of the control element 10 are connected at their radially inner ends to a hub 23, which is connected in a non-rotatable fashion—for example by means of a press-fit connection—to the driveshaft 7.

An enlarged region of a rear cylinder 13″ is also represented in FIG. 5. In the enlarged view, it can be seen that the cylinder 13″ is connected to the rear wall 5. The piston 14″, which can be slid into and out of the cylinder 13″, is guided through an opening 24 provided in the rear wall 5. At its free end, the piston 14″ is connected to the roller 15″, which is mounted on both sides by means of a fork 25. The spring 16 is configured as a helical spring, which is wound around the piston 14″. Externally, the spring 16 is supported on the inner side of the rear wall 5, and internally the spring 16 is supported on the outer side of the fork 25. The cylinder 13″ has a cylindrical internal space 26, the volume of which varies depending on the setting of the piston 14″. The cylinder 13″ has an inlet 17″ and an outlet 19″, an inlet line 18″ being connected to the inlet 17″ and an outlet line 20″ being connected to the outlet 19″. In order to achieve flow through the cylinder 13″ in the direction of the arrows indicated, the cylinder 13″ has two valves 27A, 27B, which may for example be configured as disc non-return valves with a spring. The first valve 27A is arranged at the inlet 17″ of the cylinder 13″, and the second valve 27B is arranged at the outlet 19″ of the cylinder 13″. During a movement of the piston 14″ out of the cylinder 13″ (towards the right in FIG. 5), the first valve 27A is open so that fluid can flow through the inlet line 18″ and the inlet 17″ into the internal space 26 of the cylinder 13″, while the second valve 27B is closed so that no return flow can take place from the outlet line 20″. This step is also referred to as “suction”. During a movement of the piston 14″ into the cylinder 13″ (towards the left in FIG. 5), on the other hand, the settings of the valves 27A, 27B are reversed: the first valve 27A is closed so that no return flow can take place into the inlet line 18″, and the second valve 27B is open so that the fluid can be expelled by the piston 14″ from the internal space 26 of the cylinder 13″ through the outlet 19″ and the outlet line 20″. This step is also referred to as “displacement”.

The construction described above, and the functionality explained in more detail above relate not only to the rear cylinders 13″ shown in FIG. 5 but to all five rear cylinders 13″ and—in a corresponding way—all five front cylinders 13′ of the axial piston pump 1.

The axial piston pump 1 presented above is designed in such a way that, with a power of about 3300 kW, a pressure of about 200 bar and a rotational speed of about 10 rpm, it has a delivery power of about 8900 l/min.

FIG. 6 shows the use of the axial piston pump 1 of FIG. 1 in an offshore wind turbine in a schematic representation. The wind turbine 28 shown in FIG. 6 comprises two towers standing on the bottom of a body of water, on each of which a gondola 30 is affixed. A rotatable rotor 31, respectively with three rotor blades 32, is provided on each gondola 30. Arranged in the two gondolas 30 is a pump, which may be the axial piston pump 1 described above. The wind turbine 28 additionally comprises a platform 33, likewise standing on the bottom of the body of water, on which a supply pump 34, a turbine 35, an electrical generator 36 and an electrical transformer 37 are arranged.

The wind turbine shown in FIG. 6 has two liquid circuits, the liquid preferably being water, in particular seawater or saltwater. Starting from the supply pump 34, the water is pumped through a supply line 38, which is divided into two low-pressure lines 39. The low-pressure lines 39 convey the water to the two towers 29 and to the two axial piston pumps 1 arranged in the gondolas 30. There, the low-pressure lines 39 are connected to the suction connections 21, already described above, of the axial piston pumps 1. The rotors 31 are connected by means of the flanges 8 directly to the driveshafts 7 of the axial piston pumps 1, so that rotation of the rotors 31 leads to rotation of the driveshafts 7. If required, gearing may be provided between the rotors 31 and the driveshafts 7; preferably, however, the rotors 31 are connected directly to the driveshafts 7 of the axial piston pumps 1, so that no conversion of the rotational speeds and torques takes place. In the axial piston pumps 1, a significant increase takes place in the pressure of the water, which leaves the axial piston pumps 1 through the pressure connections 22′, 22″ and is pumped from there through high-pressure lines 40 to the turbine 35 arranged on the platform 33. The water flows through the turbine 35, the water pressure being reduced, and subsequently flows back to the supply pump 34, so that the circuit is a closed circuit.

The pressure difference between the entry and exit of the turbine 35 leads to conversion of potential and kinetic energy of the water into rotational energy, which leads to rotation of the turbine shaft. The turbine shaft transmits the rotational energy to the electrical generator 36, which generates an AC electrical voltage. In the wind turbine 28, the generation of electrical energy has thus been relocated from the gondola 30 into the platform 33. Further components, for example brakes, couplings and gearing, may be provided between the turbine 35 and the electrical generator 36. The AC voltage may subsequently be converted in an electrical transformer 37. The electrical transformer may, for example, be a converter (change of frequency and amplitude of the AC voltage) or a rectifier (conversion of AC voltage into DC voltage). The output of the electrical transformer 37 is connected to a high-voltage line 41, by which the electrical energy generated can be fed into the grid.

For reasons of simpler representability, the wind turbine 28 shown in FIG. 6 has a platform 33 to which two towers 29 are connected. As an alternative, it would also be possible to connect a larger number of towers 29 to the platform 33, for example parts of an “offshore wind farm”.

FIG. 7A shows a radial piston pump 42 according to the invention in perspective view from the front side and FIG. 7B shows the same radial piston pump 42 in perspective view from the rear side. The radial piston pump 42 has a frame 2′, which is configured in the shape of a ring and comprises a front wall 4′ and a rear wall 5′. The front wall 4′ and the rear wall 5′ are approximately round and are separated from one another by a plurality of spacer rods 6′ distributed over the circumference, in such a way that the front wall 4′ and the rear wall 5′ are arranged in parallel planes.

The radial piston pump 42 shown in FIG. 7A and FIG. 7B additionally has an annular control element 10′, which may for example be connected to a rotor shaft (not shown in FIG. 7A and FIG. 7B) of a wind turbine and therefore be driven by the rotor shaft. A rotational movement of the rotor shaft therefore leads to a rotational movement of the control element 10′. The control element 10′ has a control surface 12′″ directed radially inwards, which is configured with a wave-shape. Furthermore, the radial piston pump 42 shown in FIG. 7A and FIG. 7B has twelve cylinders 13′″ and twelve pistons 14′″ assigned to these cylinders.

The cylinders 13′″ and the pistons 14′″ of the radial piston pump 42 shown in FIG. 7A and FIG. 7B are mounted tiltably on the frame 2′, to which end bearings 43 are provided in the front wall 4′ and in the rear wall 5′. By the tiltable mounting, the cylinders 13′″ and the pistons 14′″ can be rotated about the bearing 43, although this takes place only to a very small extent (less than 5°) during operation. The cylinders 13′″ and the pistons 14′″ are arranged circularly around a central axis M and are oriented in the radial direction—i.e. radially with respect to the central axis M.

In the radial piston pump 42 shown in FIG. 7A and FIG. 7B, the pistons 14′″ are connected—for example by means of piston rods—to rotatably mounted rollers 15′″. The rollers 15′″ are arranged in such a way that they roll on the radially inwardly directed control surface 12′″ of the control element 10′. Because of the wave-shaped configuration of the control surface 12′″, the position of the control surface 12′″ in the radial direction varies during rotation of the control element 10′. The effect of this is that, when there is an increased axial width of the control element 10′ (smaller radial distance between the control surface 12′″ and the central axis M) the rollers 15′″ are pushed inwards in the radial direction (i.e. in the direction of the central axis M). The result of this is that the pistons 14′″ connected to the rollers 15′″ are pushed into the cylinders 13′″ assigned to them, and in doing so displace the fluid located in the cylinders 13′″. On the other hand, a reduced axial width of the control element 10′ (larger radial distance between the control surface 12′″ and the central axis M) has the effect that the rollers 15′″ can be moved outwards in the radial direction (i.e. away from the central axis M). To this end, the radial piston pump 42 has twelve springs 16 which push the pistons 14′″ out of the cylinders 13′″. For example, a helical spring 16 is wound around each piston 14′″. The effect of the spring forces is that the rollers 15′″ always follow the contour of the control surface 12′″, and the pistons 14′″ connected to the rollers 15′″ are withdrawn again from the cylinders 13′″ assigned to them, the cylinder volume increasing again. The rollers 15′″ are thus mounted in such a way that they roll on the control surface 12′″ of the control element 10′.

In the radial piston pump 42 shown in FIG. 7A and FIG. 7B, the volume in the cylinders 13′″ can thus be cyclically varied by rotation of the control element 10′. In order to be able to use the cyclic variation of the cylinder volumes for the delivery of a fluid, each cylinder 13′″ has an inlet 17′″ with an inlet line 18′″ and an outlet 19′″ with an outlet line 20′″. The inlet lines 18′″ of all the cylinders 13′″ are brought together at a common suction connection 21′. In a similar way, the outlet lines 20′″ of the cylinders 13′″ are brought together at a common pressure connection 22′″.

The radial piston pump 42 shown in FIG. 7A and FIG. 7B has a non-rotatable support ring 44, which is for example connected to the frame 2′. Trailing arms 45 are rotatably mounted on the support ring 44 and are likewise connected to the rollers 15′″ in a rotatably mounted fashion. Preferably, each roller 15′″ is assigned its own trailing arm 45, so that the number of trailing arms 45 may correspond to the number of rollers 15′″. The trailing arms 45 are used for the purpose of absorbing forces extending in the circumferential direction and keeping the pistons 14′″ substantially free of transverse forces. The support ring 44 and be seen clearly in FIG. 7A and the trailing arms 45 can be seen clearly in FIG. 7A.

The radial piston pump 42 of FIG. 7A is represented in a perspective view in FIG. 8. Those regions of the radial piston pump 42 which have already been described in connection with FIG. 7A and FIG. 7B are provided in FIG. 8—and in all further figures—with corresponding references. The front view makes it possible to look at the trailing arms 45: each trailing arm 45 is rotatably connected to the support ring 44 by means of an articulation point 46. The effect of this is that the rollers 15′″ mounted rotatably at the other end of the trailing arms 45 can move only along a circular path B (schematically represented in FIG. 8). The result of this is that the “pump elements” (i.e. the units consisting of cylinders 13′″ and pistons 14′″) can be tilted slightly in the circumferential direction and counter to the circumferential direction when the rollers 15′″ roll on the control surface 12′″ of the control element 10′. The tiltability of the “pump elements” is made possible by the fact that the cylinders 13′″ are connected tiltably to the frame 2′ by the bearings 43. The “pump elements” are thus not exactly arranged radially in every setting; since the deviations are minimal, however, the term “radial piston pump” may nevertheless be used.

FIG. 9 shows the radial piston pump 42 of FIG. 7A in a side view. In FIG. 9 is well, those regions of the radial piston pump 42 which have already been described in connection with FIG. 7A to FIG. 7B are provided with corresponding references. In the side view, the particularly narrow design of the radial piston pump 42 in the axial direction can be seen. In addition, the suction connections 21′ and the pressure connection 22′″ on the rear side of the radial piston pump 42 can be seen. The side view furthermore shows that the trailing arms 45 may be configured with a fork shape (or Y-shape) and may therefore enclose the rollers 15′″ on both sides and reliably guide them.

FIG. 10 shows the radial piston pump 42 of FIG. 7A in a plan view. In FIG. 10 is well, those regions of the radial piston pump 42 which have already been described in connection with FIG. 7A to FIG. 7B are provided with corresponding references. In the plan view as well, the very slender design of the radial piston pump 42 in the direction of the central axis M can be seen clearly. Likewise, the connections (suction connection 21′, pressure connections 22′″) provided on the side can be seen clearly.

Lastly, FIG. 11 shows the use of the radial piston pump 42 of FIG. 7A in an offshore wind turbine 28 in a schematic representation. As a supplement to the schematic overall construction shown in FIG. 6, FIG. 11 is intended to make it possible to look into the interior of the gondola 30 of the wind turbine. In FIG. 11 is well, those regions of the radial piston pump 42 which have already been described above are provided with corresponding references. The low-pressure line 39 already described in connection with FIG. 6 conveys water to the tower 29 and to the radial piston pump 42 arranged in the gondola 30. There, the low-pressure line 39 is connected to the suction connections 21′, already described above, of the radial piston pump 42. The rotor 31 is directly connected to the control element 10′ of the radial piston pump 42, so that rotation of the rotor 31 leads to rotation of the control element 10′. Preferably, the rotor 31 is connected directly to the control element 10′ of the radial piston pump 42, so that no conversion of the rotational speeds and torques takes place. In the radial piston pump 42, a significant increase takes place in the pressure of the water, which leaves the radial piston pump 42 through the pressure connection 22′″ and is pumped from there through high-pressure line 40 to a turbine 35 (not represented in FIG. 11).

### LIST OF REFERENCES

1: axial piston pump
2, 2′: frame
3: base stand
4, 4′: front wall
5, 5′: rear wall
6, 6′: spacer rod
7: driveshaft
8: flange
9: bearing
10, 10′: control element
11: spoke
12′, 12″, 12′″: control surface
13′, 13″, 13′″: cylinder
14′, 14″, 14′″: piston
15′, 15″, 15′″: roller
16: spring
17′, 17″, 17′″: inlet
18′, 18″, 18′″: inlet line
19′, 19″, 19′″: outlet
20′, 20″, 20′″: outlet line
21, 21′: suction connection
22′, 22″, 22′″: pressure connection
23: hub
24: opening
25: fork
26: internal space
27A, 27B: valve
28: wind turbine
29: tower
30: gondola
31: rotor
32: rotor blade
33: platform
34: supply pump
35: turbine
36: electrical generator
37: electrical transformer
38: supply line
39: low-pressure line
40: high-pressure line
41: high-voltage line
42: radial piston pump
43: bearing
44: support ring
45: trailing arm
46: articulation point
B: path
K: piston axis
M: central axis
S: symmetry plane
Z: cylinder axis

1. A piston pump comprising:
a frame;
a control element mounted in a rotatable manner about a central axis having at least one control surface;
a plurality of cylinders, each having pistons displaceable therein;
a suction connection for an inflow of a fluid into the plurality of cylinders of the piston pump; and
a pressure connection for an outflow of the fluid out of the plurality of cylinders of the piston pump,
the plurality of cylinders being connected by lines to the suction connection and to the pressure connection,
the plurality of cylinders, the pistons, and the control element being configured in such a way that the position of the pistons in the plurality of cylinders can be changed by movement of the control element,
the plurality of cylinders and the pistons being mounted in such a way that the plurality of cylinders and the pistons do not rotate completely about the central axis when the control element rotates, and
the plurality of cylinders or the pistons are connected respectively to a rotatably mounted roller,
wherein the contact region between the rotatably mounted rollers and the control surface of the control element is lubricant-free.

2. The piston pump according to claim 1, wherein the plurality of cylinders or the pistons are arranged statically and/or tiltably relative to the frame.

3. The piston pump according to claim 1, wherein the frame has a front wall and a rear wall for mounting of the plurality of cylinders.

4. The piston pump according to claim 1, wherein cylinder axes and piston axes extend coaxially.

5. The piston pump according to claim 1, wherein the at least one control surface of the control element is configured in such a way that a plurality of strokes is executed per revolution.

6. The piston pump according to claim 1, wherein the pistons have a spring for retraction of the pistons from the plurality of cylinders.

7. (canceled)

8. The piston pump according to claim 1, wherein the cylinder axes and the piston axes extend parallel to the central axis.

9. The piston pump according to claim 1, wherein a first group of at least one cylinder having a piston movable therein, and a second group of at least one cylinder having a piston movable therein.

10. The piston pump according to claim 9, wherein the first group of at least one cylinder with their pistons and the second group of at least one cylinder with their pistons are arranged on different sides of the control element in an axial direction.

11. The piston pump according to claim 8, wherein the at least one control surface of the control element is directed in an axial direction, and the at least one control surface's axial distance from the plurality of cylinders can be modified by rotation of the control element about the central axis.

12. The piston pump according to claim 4, wherein the cylinder axes and the piston axes extend radially with respect to the central axis.

13. The piston pump according to claim 12, wherein the control element is arranged outside the plurality of cylinders and the pistons in a radial direction and annularly encloses them.

14. The piston pump according to claim 12, wherein the at least one control surface of the control element is directed in a radial direction with respect to the central axis, and a radial distance of the at least one control surface from the cylinders can be modified by rotation of the control element about the central axis.

15. The piston pump according to claim 12, further comprising trailing arms for guiding the rotatably mounted rollers, wherein each rotatably mounted roller is assigned a trailing arm.

16. The piston pump according to claim 15, wherein the trailing arms are mounted rotatably about a static support ring.

17. The piston pump according to claim 1, wherein the piston pump is configured for use in a wind turbine and comprises a pump medium that is water.

18. The piston pump according to claim 17, wherein the wind turbine has a tower with a gondola and a rotor, the piston pump and the turbine, the rotor being mechanically connected to the piston pump, and the piston pump and the turbine being connected to one another by fluid lines.

19. The piston pump according to claim 18, wherein the piston pump is arranged in the gondola, and the turbine is arranged outside the gondola and outside the tower.

20. The piston pump according to claim 18, wherein the wind turbine has an electrical generator and an electrical transformer, which are arranged outside the gondola and outside the tower.

21. (canceled)

22. The piston pump according to claim 17, wherein the wind turbine has a supply pump.
